(19) United States
(12) Patent Application Publication
(10) Pub. No.: US 2024/0212003 A1
(43) Pub. Date: Jun. 27, 2024

(54) Methods and Systems for Crowdfunding a Project

(71) Applicant: John Eric DeTitta, Fairport, NY (US)

(72) Inventor: John Eric DeTitta, Fairport, NY (US)

(21) Appl. No.: 18/582,387

(22) Filed: Feb. 20, 2024

Related U.S. Application Data
(63) Continuation-in-part of application No. 14/982,117, filed on Dec. 29, 2015, now abandoned.
(60) Provisional application No. 62/147,656, filed on Apr. 15, 2015.

(51) Int. Cl. G06Q 30/0279; G06Q 20/10; G06Q 30/0241

(52) U.S. Cl. CPC G06Q 30/0279; G06Q 20/10; G06Q 30/0277

(57) ABSTRACT

Systems and methods for online crowdfunding of projects are disclosed. One method includes a series of steps. One step is to design, via a computer system, a crowdfunding website configured to crowdfund a project. The website hosts one or more crowdfunding projects that are to be funded by a selected project funder or that are to be serviced by a selected services provider. The computer system is operatively connected to a web server operatively connected to the crowdfunding website. Another step of the method being described is to receive, from a project candidate, a request to create a crowdfunding project. The request may include a selection of a project funder associated with a desired crowdfunded amount or a selection of a services provider associated with a desired crowdfunded service. Another step of the method being described is to design, using the computer system and in response to the request, a crowdfunding project. Two more steps are to solicit and receive, from one or more internet visitors to the crowdfunding website, funds to crowdfund the project. When the project funds match or exceed a fair market value of the desired crowdfunded service, another step of the method being described is to transfer, by another computer system, at least a portion of the project funds received to the selected services provider, whereupon the selected services provider performs the desired crowdfunded service for the project candidate. Or, when the project funds match or exceed the desired crowdfunded amount, another step of the method being described is to transfer, by the other computer system, at least a portion of the project funds received to the selected project funder, whereupon the selected project funder electronically transfers the desired crowdfunded amount into a bank account of the project candidate.

### REFERENCE TO RELATED APPLICATIONS

This US patent application is a continuation-in-part (“CIP”') of nonprovisional patent application U.S. Ser. No. 14/982,117—filed Dec. 29, 2015—which, in turn, claims priority to U.S. Ser. No. 62/147,656, filed Apr. 15, 2015, both of which are hereby incorporated by reference in their entirety pursuant to Title 35, United States Code, §120.

### FIELD

The present subject matter —methods and systems for crowdfunding a project— is designed to match hosted projects to crowdfunding project funders or service providers.

### BACKGROUND

Crowdfunding events pool money or resources of two or more people, to advertise various products and services, such as restaurants. Often, two or more people may pool their money to attract participants to assorted charities or to draw potential participants to advertised educational or special entertainment events. There are many more examples. In 2013, the crowdfunding industry is believed to have raised more than $5 billion globally.

US 2016/0240026 to Wise discloses an apparatus and methods concerning a crowdsourced database of content featuring content uploaded to achieve a desired outcome for a contributing user. Methods involve a user-based voting system for limited time periods to establish geographical areas and enable internet votes of contributing users at a starting page to go to a state page and thereafter to a national page to award a prize or other outcome to a contributing user acquiring most votes on a national level. Each contributing user must pay a state fee to be included in that state's voting process.

US 2016/0232633 to Camelio discloses a third-party web-based application to build and automatically generate webpages offering crowdfunding opportunities to artists. The system includes one or more servers. Each server is operatively connected to a first user device and a second user device. Each server is adapted and configured to receive, from the first user device, information regarding a project of an artist and then generate project data based on information received regarding the project. Project data includes name of artist, foreign language skills, start date, estimated completion date, and more.

US 2016/0225037 to Ezumba discloses a crowdfunding portal or website whereby a pool of funds, generated by a percentage of donation activities on its portal, is used to fund certain preselected automated campaigns on a crowdfunding portal, based on an algorithmically calculated score generated by sufficient user activity for each campaign. The pool of funds is governed by select portal members. An advertising model is generated to respond to interests of portal members. A third-party fundraiser commission payment model encourages users to share crowdfunding portal campaigns, resulting in a fundraising community of interested parties raising funds for their crowdfunded projects.

US 2016/0180282 to Basalamah et al. discloses a system and method for crowdfunding and crowdsourcing a project that receives, via communication circuitry, a project from a user. Another step of the method determines, using processing circuitry, whether the project adheres to predetermined criteria. A further step of the method provides the project to a crowdsourcing community as well as a crowdfunding community. Another step of the method receives bids from one or more freelancers to implement one or more parts of the project. A further step of the method receives contributions from one or more contributors. Another step of the method is to select at least one freelancer based upon a pre-established rule. A further step of the method determines the total amount of contributions. Another step of the method determines the total amount of funds needed. A further step of the method is to determine whether the total amount of contributions is at least equal to the total amount of funds needed. A further step of the method assigns one of more parts of the project to the selected at least one freelancer. Another step of the method is to transmit an alert to at least one device associated with the selected freelancer. A further step of the method is to submit payment to the selected freelancer.

US 2016/0171614 to Buckner discloses a method for an interactive crowdfunding platform including receiving a device a plurality of video crowdfunding offerings from a production server for products, each associated with a respective data portal, where the video crowdfunding offerings are in a format viewable a viewer device, and transmitting a response to a respective data portal to indicate a purchase of security for the product based upon a particular video crowdfunding offering. A production server microprocessor is configured to transmit an alert to the viewer device in response to a video crowdfunding offering matching stored preferences for the viewer. The alert includes at least one selection from a group consisting of an investment category, a price for the security, and a universal resource locator (URL) specifying locations of portals to purchase the security.

US 2016/0110776 to Pratt is directed to a system and method for gamified crowdfunding over the internet, to crowdfund worthy or charitable causes while offering incentives and rewards in the form of an entertaining game and potential added benefit of a share of the proceeds. Proceeds from gamified crowdfunding can be shared between a worthy cause and a high scoring donor participant. A host identifies and selects, through a contest or other means, an advertised cause. A host possesses or owns a server with a processor and memory in which to store a game of knowledge or skill. A game interface and the server are accessed by users via a network. Via the game, queries and answers are exchanged. Through a personal computing device, users create accounts, transfer funds for supporting one or more causes, and interact with the game and with each other.

US 2016/0035034 to Mathews, II discloses a network-based system adapted and configured for presenting subscribers of a crowdfunding platform with an aggregation of entrepreneurial project funding opportunities derived from various sources, and designed to deliver to subscribers, social media content associated with entrepreneurial project funding opportunities and award notifications based on a level of subscriber contribution.

US 2015/0170043 to Hernandez et al. is directed to a decentralized expert system for network-based crowdfunding. Crowd services can be broken down into crowdsourcing and crowdfunding. Crowdsourcing describes methods in which a large group of users function as a swarm to perform a task. Co-written articles in the internet encyclopedia wikipedia.org are an example. Crowdfunding, in comparison, describes a swarm of users group-financing an investment. Examples of group-financing include but are not limited to product-based (i.e., reward-based) crowdfunding of the sales platforms kickstarter.com or indiegogo.com —in which a user group, as a rule, pre-finances commercial production of a product— or “equity-based” crowdfunding on such platforms as wefunder.com or seedmatch.de. Equity-based crowdfunding could also be referred to as “crowd investing.”

US 2015/0032652 to Brandes discloses systems and methods encouraging potential donors to become actual donors for projects seeking crowdfunding. In embodiments, streaming video conversations, individual personal profiles, and fundable project descriptions provide potential project donors with in-depth contextually relevant information resource presentation materials related to the projects seeking crowdfunding.

US 2014/0351116 to Hoff discloses systems and methods to fund a risk by pairing a fundable business and a beneficiary, to present to investors and crowdfunding backers. Fund suppliers channel funds through a crowdfunding portal, or broker, for providing debt to a fundable business. During designated times, all or a portion of the repayments may be returned to an investor by a beneficiary via the crowdfunding portal, allowing investors to supply funds to a business without the investors directly lending to the businesses, and allowing businesses to borrow funds without subsequent repayment by the businesses.

US 2014/0279682 to Feldman discloses a system and method for managing crowdfunding platform information. In one aspect, the system provides a useful way for users to search, filter, compare, and display information relating to investment platforms. The system collects information relating to users and their proposed ventures, matching ventures with investment platforms. The system can also match users with investment ventures, provide a comprehensive information database for investment platforms, and connect users with various professional services based on user activities and industries.

US 2014/0040157 to Cohen et al. discloses apparatuses, methods, and systems designed to encourage participation by plural users of a crowdfunding platform based upon information gathered from multiple user activities across one or more campaigns. An offer may be provided to a fundraiser offer based on a campaign category, a campaign keyword, a campaign profile, an offer profile, or user-activity histories. A user profile may be used to determine an offer by comparing a user profile to attributes of one or more offers. A selected offer can be presented to such users as funders, fundraisers, or others.

US 2014/0025473 to Cohen is for a crowdfunding platform receiving an indication that an entity has completed “an action.” Examples of an entity are a funder, a campaign account owner, a third party, and combinations of such. Examples of “an action” may include buying something, subscribing to a service, joining an entity's social network, etc. Upon receiving an indication, an account (e.g., a crowdfunding account such as a funder and/or campaign account) can be credited with a value corresponding to the completion of the action. Value can be transferred from an external account (such as travel rewards programs, external virtual currency accounts, and so forth) to a crowdfunding account and vice versa. If a transferor account is denominated in a different unit of value than a transferee account, an exchange rate may be determined and applied to the transaction.

US 2009/0192873 to Marble, for example, discloses apparatuses, methods, and systems designed to foster donation-coordinating electronic-market platform-coordinating interactions and transactions between participants for facilitating allocation of charitable donations based on consumer purchases. The platform, at the intersection of charitable giving and retail transacting, is enabled by web-tools, search technologies, and electronic transaction processing. As such, many new relationships are formed by creating new sets of technology links and functionality. The platform is configurable to collect, maintain, and update profile information for all participating entities; to link sales, marketing, advertising, and financial settlements; to track and report consumer purchases, charitable donations, and advertising efficacy; to build loyalty of participants; and to foster donation momentum.

US 2015/0006363 to Sabhani et al., for automated online college scholarship donations, discloses methods and systems designed to automate charitable donations by merchants. In one embodiment, a donation agent interacting with a merchant website can offer an online user an option to allocate at least a portion of a payment for or price of a purchase, associated with a transaction made by the user via the merchant website, to be donated by a merchant corresponding to the merchant website on behalf of the user to a charity of the user's choosing. If the online user exercises the option, the donation agent can calculate an amount for a donation to be made and store the calculated donation amount in a database. The donation agent can disburse the calculated donation amount to the charity selected by the customer. The method also works for the off-line model. The points earned can be combined with a college scholarship award mechanism.

As an example of certain prior art noted above, a project creator may use a crowdfunding website to raise funds for a new project. The creator defines the project and sets a crowdfunding goal. Project information can include the background or purpose of a project, the goals of the project, and more. Successful projects may include images or videos. The creator may offer rewards for certain funding amounts. For example, at a first funding level a funder may receive a personal “thank you.” At a second funding level a funder may receive an advance memento of a project (art, music, movie). At a third funding level a funder may receive an offer to meet the project creator and so on. Once a crowdfunding goal is met the crowdfunding website provides the funds (less a “processing” fee) to a project creator, and the project creator can then “start” the project.

Current crowdfunding methods and systems provide the raised funds directly to a project creator. However, this can raise several concerns. For example, some people may be hesitant to fund projects, whose creators they don't know. There may also be concerns as to whether a project creator, in fact, receives the full crowdfunded amount. Current crowdfunding methods and systems also create issues for a project creator. For example, instead of focusing on a project, the creator must be concerned with money management.

Therefore, methods and systems that eliminate money-management concerns and allow project creators to receive funds free of such concerns, pose an ongoing need.

### SUMMARY

The present disclosure is directed to improved methods and systems for crowdfunding a project in which a project generator, producer, designer, or creator receives predetermined crowdfunded funds and/or resources from an available service provider via an available opportunity offered by that service provider, rather than receiving funding directly. For example, when the project creator creates the project, the project creator reviews several service providers and then selects an available service provider and a package offered by the service provider. If the project is successfully funded, the crowdfunding entity provides the funds or resources to the service provider, and the service provider provides the funds or resources to the project creator. The project can be any project requiring funding. For example, a project might be—but is not limited to—an artistic project, a theatrical performance project, or a college education funding project.

According to an aspect of the present subject matter, a method for crowdfunding a project includes a step of providing, by a computer system, a crowdfunding website adapted and configured for crowdfunding an assortment of predetermined projects. The crowdfunding website hosts a plurality of crowdfunding projects to be funded by one or more service providers. The computer system is operatively connected to a web server adapted and configured for hosting the crowdfunding website. Another step of the method for crowdfunding a project includes receiving from a project creator, designer, or promoter a request to create a crowdfunding project. The request includes at least one of a plurality of services provided by the one or more service providers. The method for crowdfunding a project also includes creating, designing, or promoting a crowdfunding project by utilizing the computer system in response to the request. The method for crowdfunding a project further includes receiving, from one or more visitors to the crowdfunding website, funding for the crowdfunding project. The method for crowdfunding a project also includes transferring, by using the computer system, a portion of received funding to said one or more service providers. Such service providers provide the funding to the project creator.

According to an embodiment, the method further includes the steps of sending the request from the project creator to the service provider, and receiving, from the service provider, authorization to create or design a crowdfunding project. The request from the project creator further comprises a selection of a service provider funding package option.

According to an embodiment, the method further includes the step of receiving, from the service provider, one or more service provider funding package options. The crowdfunding project also includes setting up at least one dedicated project webpage. The step of receiving funding for a crowdfunding project includes receiving a confirmation that includes a completion of one or more funding activities performed by a website visitor.

According to an embodiment of the present subject matter, a crowdfunding project is only funded after a predetermined (and preferably clearly set forth in a document) crowdfunding goal, project, achievement or other matter has taken place or has occurred.

According to an embodiment, the method may include the step of returning a portion of the funding to the one or more website visitors from whom funding for the crowdfunding project was received. In addition, funding may include a virtual currency.

According to an aspect of the present subject matter, a system for online crowdfunding of a project includes a plurality of service providers. Each of the plural service providers is configured to fund one or more crowdfunding projects associated with a crowdfunding website. The system includes at least one web server adapted and configured to host the crowdfunding website. The system also includes at least one database in operative communication with each web server. Each database includes information about a plurality of visitors to (or users of) the crowdfunding website, the plural service providers, and a plurality of crowdfunding projects. The system includes at least one processor in operative communication with the web server and the database. Each processor is adapted and configured to receive, from a project creator or promoter, a request to create a crowdfunding project. The request may include a selection of a service provider from a plurality of service providers. Each processor is adapted and configured to create or design a crowdfunding project in response to the request from the project promoter, creator, or designer. Each processor is adapted and configured to receive from at least one of the plural website users or visitors, funding for a crowdfunding project and thereafter transfer a portion of funding received to one or more of the service providers.

According to an aspect of the present subject matter, a computer program product that includes a computer readable storage medium, which includes program instructions for causing a computer to perform a programmed method is disclosed. Such method includes providing, by a computer system, a crowdfunding website that is configured to crowdfund a project. Such crowdfunding website is, in fact, adaptable and configurable to host a plurality of crowdfunding projects, each of which may be funded by one or more of a plurality of service providers. The computer system is operatively associated with at least one web server adapted and configured to host the crowdfunding website. The computer system is adapted and configured to receive, from a project creator, a request to create a crowdfunding project. The request includes a selection of a service provider.

The computer system is adapted and configured to create or design, in response to the request, a crowdfunding project. The computer system is also configured to receive, from one or more users of or visitors to the crowdfunding website, funding for the crowdfunding project and thereafter transfer a portion of the received funding to one or more of the service providers, who authorize transfer of the funding to the project creator.

The present subject matter is directed to systems and methods for online crowdfunding for an assortment of projects. One such method includes a series of steps. One step is to design a crowdfunding website. A computer system is generally used to do so. The crowdfunding website is adapted and configured to solicit members of the public to crowdfund a project. The website hosts one or more crowdfunding projects that are to be funded by a selected project funder or that are to be serviced by a selected services provider. The computer system is operatively connected to a web server operatively connected to the crowdfunding website. Another step of the method being described is to receive, from a project candidate, a request to create a crowdfunding project. The request may include a selection of a project funder associated with a desired crowdfunded amount or may include a selection of a services provider associated with a desired crowdfunded service. Another step of the method is to design, using the computer system and in response to the request, a crowdfunding project. Two more steps are to solicit and receive, from one or more internet visitors to the crowdfunding website, funds to crowdfund the project. When the project funds match or exceed a fair market value of the desired crowdfunded service, another step of the method being described is to transfer, by another computer system, at least a portion of the project funds received to the selected services provider, whereupon the selected services provider performs the desired crowdfunded service for the project candidate. Or, when the project funds match or exceed the desired crowdfunded amount, another step of the method being described is to transfer, by the other computer system, at least a portion of the project funds received to the selected project funder, whereupon the selected project funder electronically transfers the desired crowdfunded amount into a bank account of the project candidate.

### BRIEF DESCRIPTION OF THE DRAWING FIGURES

FIG. 1 is a schematic illustration presenting an embodiment of an example of a method for crowdfunding a project, in accord with principles of the present subject matter.

FIG. 2 is a schematic illustration presenting an embodiment of an example of a system for crowdfunding a project, in accord with principles of the present subject matter.

FIG. 3 is a schematic illustration presenting an embodiment of an example of a system for crowdfunding a project, in accord with principles of the present subject matter.

FIG. 4 is a schematic illustration presenting an embodiment of an example of a method for crowdfunding a project, in accord with principles of the present subject matter.

Throughout the drawing figures and detailed description set forth below, I shall use similar reference numerals to refer to similar components of the present subject matter.

### DETAILED DESCRIPTION

According to prior art project-funding methods and/or systems, as reviewed above, a project creator first creates an account with a crowdfunding website, and then uses the crowdfunding website to create a project to be funded and noting a funding goal. Members of the crowdfunding website donate may next money and/or resources to fund the project. When a funding goal is reached or exceeded, the crowdfunding website may provide money to the project creator who may then begin to work on the project. For reasons set forth above, many prior art methods or systems are inefficient and may cause problems.

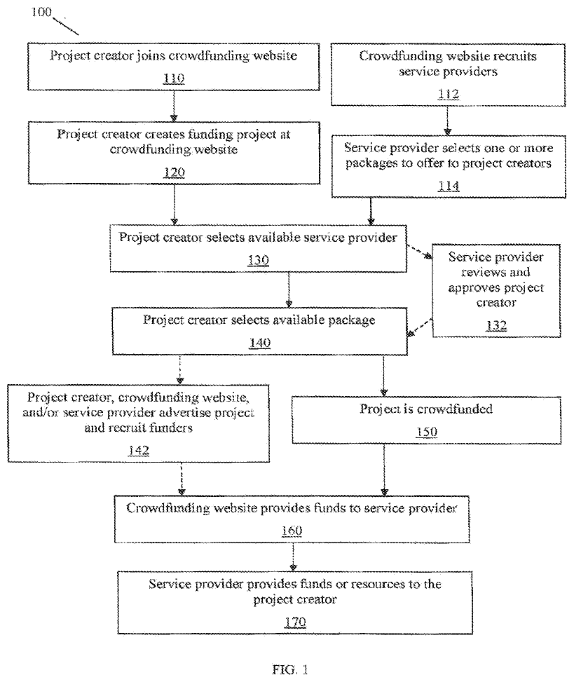

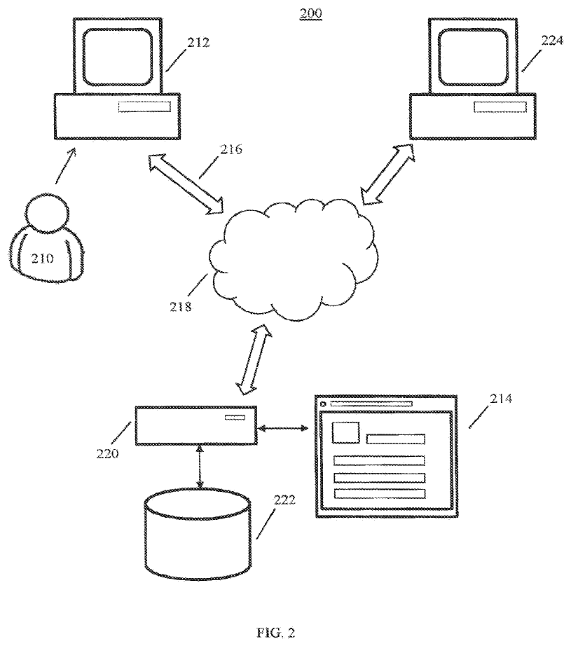

FIG. 1 depicts an embodiment of a flowchart or method 100 for crowdfunding a project. FIG. 2 depicts an embodiment of a system 200 that uses the flowchart or method 100 to crowdfund a project. At step 110, a project generator or creator 210 at a first computer 212 is invited to join a crowdfunding website 214. The project creator 210 is prompted at this time to create a personal profile populated with required and/or voluntary information including but not limited to name, background, other crowdfunding projects, etc. The first computer 212, and other computers operatively connected to the website 214, may include but not be limited to an Apple computer, a conventional “other” laptop, a personal digital assistant, an I-Pad, a cellular telephone, a smartphone, a handheld device, a smart watch, and combinations of these, including internet-connected devices having at least one processor and a connection 216 to a computer network 218. The computer network 218 can be a cloud server, the Internet or any network system known to a person of ordinary skill in the art (“POSITA”). For example, computer network 218 may be a combination of local area networks (“LAN”), wide area networks (“WAN”), etc.

In accordance with the present subject matter, the crowdfunding website 214 can be associated with a corporate entity including but not limited to a publicly owned or privately owned company, a partnership, or other business organization chartered to raise funds for charitable or other purposes via methods disclosed in the prior art noted above. For instance, website 214 may be hosted on a server 220 owned or leased by one or more crowdfunding entities. The server 220 may include one or more databases 222, each database 222 retaining information including but not limited to crowdfunding entities, crowdfunding project creators (including project designers, developers, and promoters), crowdfunding service providers, their service provider packages, and/or funding pledges.

Returning briefly to FIG. 1, recall step 110 where a project generator or creator 210 at a first computer 212 was invited to join a crowdfunding website 214. At step 120, the project generator or creator 210 responds to the invitation and creates a funding project. The project can be aimed at creating a new piece of art or music, a screenplay, or various articles of crowdsourced “merch” for an unlimited number of crowdfunded projects. To create a funding project, a project creator 210 provides information including but not limited to the purpose or goals of the project, the background of the project, the future of the project, information about the members of the project, and other information.

At step 130, the project generator or creator 210 may select an available service provider 224. A service provider 224, in accordance with the present subject matter, is an entity that provides a predetermined amount of funding for a preselected project and is refunded by a crowdfunding entity associated with a particular crowdfunding website 214.

For instance, a service provider, according to the present subject matter, may be a company, a business, a person, or an entity that provides products or services that the project generator or creator 210 needs, including but not limited to a music equipment company, a recording studio, a caterer for a dinner party, an movie editor or producer, a self-publishing company for a book, or a manufacturer of a particular timepiece or vehicle.

The project generator or creator 210 may select from a list of service providers 224 if multiple providers are available. The selection may be limited, for example, to only those service providers that provide funding or resources, for which a particular category of crowdfunding projects belongs. As another option, a service provider 224 may perhaps only provide funding to select groups of individuals, including but not limited to people from a certain geographic location, people of a particular demographic, and such. As yet another option, a service provider 224 may only provide funding at certain times or dates.

To provide a particular project generator or creator 210 with ideas and/or options for crowdfunding, it may be necessary for the crowdfunding entity 214 to request, recruit, or otherwise gather one or more service provider entities 224. Accordingly, referring again to FIG. 1, the crowdfunding entity associated with the crowdfunding website 214 recruits, at step 112, one or more service providers 224. According to a preferred embodiment, a particular crowdfunding entity associated with website 214 recruits a plurality of service providers 224, each of which is associated with a second computer 226, thus ensuring a greater likelihood that a project creator 210 finds suitable service providers 224. (FIG. 2.)

Accordingly, when a service provider 224 is added to a crowdfunding project, that service provider 224 can present a selection of one or more crowdfunding-inducement packages to offer a crowdfunding project generator or creator 210 at step 114. (FIG. 1.)

An assortment of crowdfunding packages are possible. For instance, a project promoter or creator 210 may select one or more of a variety of suggested crowdfunding packages. Or one or more crowdfunding entities associated with at least one service provider 224 may advertise a standard crowdfunding package via a crowdfunding website 214 for a particular crowdfunding project. Or a service provider 224 may select a package suggested either by a crowdfunding entity or by a crowdfunding promoter or creator 210.

At optional step 132 of method 100, it may be necessary for a service provider 224 to vet, review, or approve a project of promoter or creator 210. For instance, a service provider 224 may wish to review the background, biography, or background of a project promoter or creator 210 before authorizing a particular crowdfunding project. Or a service provider 224 may only wish to review the credentials of an untested crowdfunding project generator, promoter, or creator 210. After authorization to proceed is granted to a project generator, promoter, or creator 210, method 100 proceeds to step 140, where the project generator, promoter, or creator 210 selects from among one or more possible funding packages. Typically, the selection of funding packages will be defined by the selected crowdfunding service provider. For example, crowdfunding service provider “A” may provide a first selection of funding packages and service provider “B” may provide a second selection of funding packages. There may, or may not, be overlap between the first and second funding packages. According to an embodiment, a package may be a specific crowdfunding project category, a specific crowdfunding service category, or a specific crowdfunding product or service. For example, the package may be a music demo service having a fair market value of about $5,000. As additional nonlimiting examples, a particular crowdfunding package may be catering service for a documentary having a fair market value of about $2,500, or may involve self-publishing of a 250-page book, for which a fair market value is about $250, or a package may include 3D-printing, for which a fair market value is about $35, or editing services for three cents a word, etc.

At step 142, which is optional, of method 100, a project promoter or creator 210, a crowdfunding entity, and/or a service provider 224 will advertise the crowdfunding project, typically on one or more crowdfunding websites 214, to recruit funders. For example, a particular crowdfunding project may be advertised on the internet by using internet properties which may be owned by at least one of these entities. As another example, a crowdfunding entity or service provider 224 may provide a newsletter, a blog, or another advertising tool to highlight one or more crowdfunding projects. Any method of bringing project awareness to potential funders may be used. As another example, a crowdfunding entity and/or a service provider 224 may only advertise the crowdfunding project to particular funders, such as previous funders or those more likely to fund this category of project, which can be determined based on preferences or on past funding experiences.

At step 150 of method 100, when a potential crowdfunding entity funds a project, which may be done by promising that a certain amount of funding or resources will be given to a crowdfunding project generator or creator 210, as soon as a project is funded (100% or more) within 10 days, or if funds or resources, sufficient to cover a crowdfunding project, is given to a generator or creator 210, in cash, by at least one crowdfunding entity.

According to an embodiment of the present subject matter, individuals earn funding (such as “virtual” funding as described in detail below), “points,” or an “equivalent value” component by engaging in crowdfunding activities, to earn funding or points awarded by either at least one crowdfunding service provider 224 or at least one crowdfunding entity. A crowdfunding participant may then give (or donate) the funding “award” or “points” to a project (or “cause”), a person (or “personality”), or a preselected crowdfunding category.

Optionally, an individual receives a portion or percentage of funding or points awarded. A participant will preferably set up an account with a particular service provider 224 to track the funding, points, or other value components. And, in accordance with an embodiment of the present subject matter, a crowdfunding participant may earn or be awarded points or funding by watching select videos, searching the Internet for select items, shopping online, completing tasks, answering questions, taking surveys, inviting friends to participate in crowdfunding projects, reviewing advertising, and so much more.

As another example, crowdfunding project generators, promoters, or creators 210 and/or crowdfunding participants may be invited to sell select merchandise through a crowdfunding website 214 and/or through another forum associated with at least one crowdfunding website 214. In such cases, either a portion of the crowdfunding proceeds will be donated to predetermined crowdfunding projects, or participants may convert cash into a crowdfunding website currency which may be used to purchase an assortment of merchandise, where at least a portion of the cash may be used for crowdfunding projects.

For each of these activities, a participant may earn or be awarded points or funding. When a participant turns over the points awarded or funding amount earned to the site 214 or to a project creator 210, the participant may receive a reward such as a gift card, a cash card, select membership or any of various crowdfunding rewards for which “points” represent value. For instance, 500 points may be equivalent to a $5.00 fair market value.

In accordance with another embodiment, a crowdfunding entity may make use of a virtual currency (such as bitcoin) to fund a crowdfunding project. In particular, a crowdfunding entity may utilize virtual currency “X” which may be purchased by at least one actual project funder and/or at least one potential project funder. Typically, at least one project funder and/or at least one potential project funder may purchase a certain amount of virtual currency “X” having government-issued or -approved currency value.

Such may be done when a project funder sets up a crowdfunding account, at any time after the account is created, and/or at the time of providing funding to or promising funding for a crowdfunding project. The amount of virtual currency “X” that can be purchased with government-issued or government-approved currency may be static or may fluctuate based on political or global events, economic factors, or charitable aspects of or within the crowdfunding entity community or one or more of the service providers. Also, a crowdfunding entity may require payment of an administrative fee when converting government-issued or -approved currency to the virtual currency “X”, and/or vice versa.

Thus, when a project promoter or creator 210 selects a crowdfunding package, one or more crowdfunding entity and/or one or more associated crowdfunding service provider 224 may convert cost of a crowdfunding package to virtual currency “X” and display that amount rather than a government-issued or government-approved currency amount. For example, if a project creator 210 selects package “4” from service provider “B,” with package “4” being a 3D-printing of a 5-pound object having a fair market value (“FMV”) of $250, the crowdfunding entity or crowdfunding the crowdfunding service provider may convert the $250 evaluation to an equivalent amount of virtual currency “X,” which may, for example, be 5,000 tokens, or 300 X's, or an assortment of other options.

The project website will then display the need for 300 X's, for example, and funders may provide or promise a predetermined percentage of the X's from their own accounts. Once promised or provided, for example, a funder's profile may reflect that the promised or provided amount of X's have been removed, or set aside, for the crowdfunding project.

After the crowdfunding project has been fully or adequately funded, the funding and/or the resources are exchanged between parties described above, according to step 160 (at least one crowdfunding website 214 provides funds to at least one crowdfunding service provider) and step 170 (the at least one crowdfunding service provider provides funds or resources to the project generator, promoter, or creator 210) of method 100. (See FIG. 1.) There may be a requirement set forth by at least one crowdfunding entity, or at least one service provider 224, or at least one project promoter or creator 210 that a crowdfunding project is only funded if the requested amount is achieved or is only funded if a requested amount is achieved within a finite timeframe, or that a crowdfunding project is only funded if predetermined amount is achieved by a predetermined number of funders, or if the predetermined amount is achieved by a variety of other acts or deeds.

There may also be no such requirement that the project receive any funding. Also, a crowdfunding project may end if no funding is received within a predetermined amount of time. Moreover, there may be an option set forth by the crowdfunding entity, a service provider 224 and/or a project promoter or creator 210 that a crowdsourcing project ends as soon as an objective is achieved. For other crowdfunding projects, one or more of the crowdfunding entities may determine that the crowdfund project be permitted to continue for a predetermined period of time, regardless of whether a funding objective is achieved.

For example, at step 160, a particular crowdfunding goal is reached and the crowdfunding website 214 provides select crowdfunding funds to service provider. Such an event occurs because at step 170, a service provider and not a crowdfunding website 214 provides the funding or resources directly to the project promoter or creator 210. Providing such funds or resources to a service provider at step 160 may include converting virtual currency to a more standard government-issued or -approved currency.

Many benefits of the improved method and system for crowdfunding a project, in accordance with the present subject matter, should immediately be clear to a person of ordinary skill in the art (“POSITA”). For example, a service provider may provide a service rather than funds to a project creator 210, in which case certain steps, whereby a crowdfunding entity provides funds to a project creator 210, who then must negotiate with a third-party service provider, are eliminated. Instead of being concerned about finding a suitable service provider for a budgeted cost, a project promoter or creator 210 may immediately work with the selected service provider 224, since the project is now funded.

As one example of a benefit derived from the improved method of the present subject matter, a project generator or creator 210 with a desire to record music in a professional recording studio, contacts a crowdfunding entity and outlines a crowdfunding project to raise money to lease an available professional recording studio for three (3) days. From twenty-five available recording studios that could be paid by the crowdfunding entity, the project creator 210 selects a professional recording studio located nearby. The recording studio offers a package for three days' work worth virtual currency $2,000“X” (approximately $5,000 USD), and the project creator 210, an amateur musician, selects the offered package. A crowdfunding website 214 is created and displayed by the crowdfunding entity. The project creator 210 provides links to the recorded event, for example, via social media accounts for the crowdfunding website 214 to provide to the public. The crowdfunding entity and the service provider (the nearby recording studio) do likewise. The crowdfunding entity highlights the project in its weekly e-newsletter, and the recording studio notes the project on physical bulletin boards and on its website, among many other places. Over the course of the next 30 days, more than $2,200“X” is raised, and the project ends on the 30th day as planned. The funders all provide their promised amount of “X” to the crowdfunding entity. The accumulated or collected $2,200“X” is converted to approximately $5,500 USD, given by the crowdfunding entity directly to the recording studio, less administrative fees charged by crowdfunding entity. The recording studio then contacts the musician and schedules three days' worth of work, plus editing.

There is no limit to the variety of different projects that can be funded using the projects and systems disclosed herein. Any project that can be described and associated with a crowdfunding website, and that can potentially recruit from website users, can be used in the crowdfunding method. Typically, a project has well-defined objectives and goals such as recording a song, writing a book, creating a painting, or producing a film. A project can also be something completed with something tangible being produced. The crowdfunding website may prohibit certain projects if they include objectionable material including pornographic material, drug-related material, hate material, and other projects objectionable to the public. Accordingly, it may be necessary for the crowdfunding website to comprise an authorization step, in which one or more reviewers are authorized to review a project submission for objectionable material as outlined above and must approve the submission before it can be funded or advertised. The crowdfunding website may also comprise a periodic review to prevent or remove objectionable material. Additionally, a crowdfunding website may also include a notification system in which users of the website can notify the crowdfunding website administrators to objectionable content which the administrators can then review and curate, remove, and/or otherwise address.

As just one example of a project that could be funded, an engaged couple who are getting married at a future date creates a funding project to fund their wedding. The couple select an available “wedding funding” package from a list of available wedding services providers who offer wedding funding services, who review and accept their project. The couple select one and their package is crowdfunded in whole or in part by crowdfunding website visitors. For example, an engaged couple may send requests to friends and family members to visit crowdfunding website. The crowdfunding website provides funds to the service provider. The service provider, in turn, provides funds to the project creator. The visitors also receive a reward for visiting and donating to the funding for the project.

As another example of a project that could be funded, a high school senior headed to college for an initial Autumn Session at a local college or university may request, propose, provide, or design a college funding project to fund his/her college education.

He/She may select a standard or customized “college funding” package from among a list of available service providers who offer college funding services, some of whom may review his/her project. His/her college-funding project becomes crowdfunded, in whole or in part, by website visitors. The crowdfunding website provides his/her college funds to a service provider and the service provider provides the funds to a project creator. The website visitors may also receive a reward for donating to the college funding project.

As another example of a project that can be funded, an author who is currently working on a new book or who would like to be working on a new book, designs or creates a crowdfunding project to fund his/her new book project. He/She selects a standard or customized “book funding” package from a list of available book funding service providers who offer book funding services. The author advertises his/her project to friends, family, and readers of her other books. Many visit the crowdfunding website, engage in fundraising activities, and his/her project becomes funded. The crowdfunding website provides funds to a service provider, and the service provider provides funds to the project creator. Website visitors may receive a reward for donating to the book funding project.

The system of the present invention may include a plurality of computers. Each computer may include at least one user interface. Exemplary computers include but are not limited to laptop computers, desktop computers, so-called personal computers (PCs), and Apple computers. Additional exemplary computers include but are not limited to smart devices including but not limited to tablets and smart phones. Each computer may include a program product including but not limited to a machine-readable program code adapted and configured for causing, when executed, the computer to perform an assortment of predetermined steps. The program product therefore may include software which may either be loaded onto one of the computers described or accessed by such computer. Also, loaded software may include an application on a smart device. Software may be accessed by such computers using a web browser. The computers may access software via a web browser using the internet, an extranet, intranet, host server, or “internet cloud.”

The computer-based data processing system and method—described above—is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may operate or be run on a stand-alone computer system or may operate or be run from a server system accessed by a plurality of client computer systems interconnected over an intranet network, or accessible over the Internet. In addition, many embodiments of the present invention have application to a wide range of industries. To an extent, the present application discloses a system, the method implemented by that system, as well as software stored on a computer-readable medium and executed as a computer program to perform the method on a general purpose or special purpose computer, are within the scope of the present invention. Furthermore, to an extent the present application discloses a method, a system of apparatuses configured to implement the method are within the scope of the present invention. It is understood, of course, that the foregoing relates to exemplary embodiments and that modifications may be made without departing from the spirit and scope of the present invention as set forth in claims.

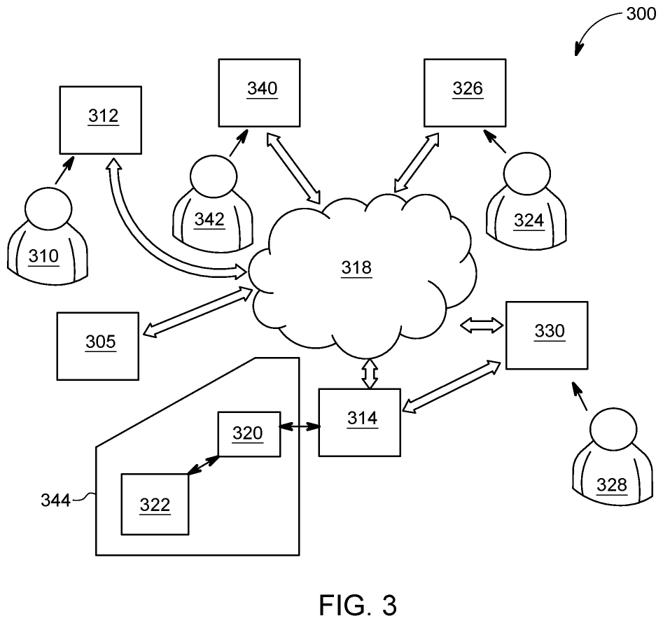

FIG. 3, a schematic illustration presenting an embodiment of another example of a system 300 for crowdfunding a project, in accordance with principles of the present subject matter, shall now be described in detail. The system 300 includes one or more first computers 312. Each of the first computers 312 is accessible by a crowdfunding project creator, designer, developer, or candidate 310. The system 300 also includes a registration-and-control component 305. A data transmission system 318 operatively connected to the first computers 312 electronically transmits data between the first computers 312 and the registration-and-control component 305 after a crowdfunding project designer, developer, or candidate 310 has become registered with the registration-and-control component 305 by inputting into the registration-and-control component 305 an access code, a description of a project to be crowdfunded, and a target crowdfunding amount associated with the crowdfunding project creator or candidate 310.

The registration-and-control component 305 in many embodiments of the present subject matter is provided with one or more computer servers or “server farms” that are remotely located. As described herein, the registration-and-control component 305 is typically accessed via the world wide web (i.e., internet) and is adapted, and configured to make use of conventional cloud-based data storage, data analysis and processing, including data transfer channels. Pursuant to the present subject matter, a crowdfunding website 314, operatively connected to the registration-and-control component 305, and which retains data for projects to be crowdfunded, includes target crowdfunding amounts input by crowdfunding candidates. Registration-and-control component 305 thus has a database including data storage provisions for which data input by candidates is retained.

The registration-and-control component 305 may therefore include communication provisions so that the component 305 can exchange, transmit, and/or receive information or other data from one or more mobile electronic devices. In embodiments of the present subject matter, registration-and-control components 305 include internet communication provisions. In many versions of the present subject matter, system 300 and particularly the registration-and-control component 305 use cloud-based storage and/or cloud-based processing (e.g., cloud-based internet storage system 318), which is accessed and/or implemented in a distributed fashion using remotely located servers, computers, and various electronic devices (e.g., smartwatches, iPads, iPhones, and other smartphones).

Typically such servers, computers or other electron devices are all accessed by the internet. Cloud-based storage and/or processing, including data transmission system 318, refers to online storage and/or processing by which electronic data is virtually stored and/or processed across one or multiple servers, all typically hosted by service providers. The term “cloud-based computing” refers to one or more cloud-based data storage, cloud-based data processing, and/or cloud-based data communication systems. Service providers may include so-called “data center operators” that virtualize resources based upon customer requirements. The storage services may be accessed via web service application programming interfaces (“API”) or web-based user interfaces (“UI”). Cloud-based computing is described in the prior art such as for example U.S. Pat. No. 8,607,242 to Clarke; U.S. Pat. No. 8,805,989 to Hemachandran et al. U.S. Pat. No. 8,966,251 to Gu; U.S. Pat. No. 9,871,857 to Russinovich et al.; U.S. Pat. No. 10,067,798 to Netto; and U.S. Pat. No. 11,650,859 to Shil, all of which are hereby incorporated by reference in their entireties.

One or more second computers 326 are operatively connected via the data transmission system 318 to the crowdfunding website 314. The second computers 326 are accessible by one or more project enablers 324. A project enabler 324 is either a crowdfunding project funder or a crowdfunding project services provider. One or more third computers 330 are operatively connected to the crowdfunding website 314. All such third computers 330 are accessible by one or more project-funds distributors 328, typically an insured and highly reputable funds retaining-and-disbursing institution such as a bank.

One or more of a wide assortment of electronic devices 340 operatively connected via the data transmission system 318 to the crowdfunding website 314 enable at least one entity 342 to donate a crowdfunding candidate gift amount via an electronic financial data transmission. An entity 342 is either a person or a business. Pursuant to the present subject matter, candidate gift amounts can be donated by family members, friends of the candidate or family, members of the public, business organizations, corporations, etc. Such entities 342 may donate a candidate gift amount corresponding to a portion, or all, of the target crowdfunding amount into a predetermined electronic financial data storage register of a storage device 344 operatively connected to the crowdfunding website 314.

For the system 300 illustrated by FIG. 3, the storage device 344 includes a server 320 operatively connected to the crowdfunding website 314. The server 320 is adapted and configured to receive and securely store at least one candidate gift amount donated by said at least one entity 342 via said electronic financial data transmission. The storage device 344 also includes a database 322 operatively connected to the crowdfunding website 314. The database 322 is adapted and configured to securely store an access code, a description of a project to be crowdfunded, and a target crowdfunding amount associated with a crowdfunding project candidate 310 registered with component 305.

Mobile Electronic Devices. The present subject matter is thus used in combination with mobile electronic devices 340. Mobile devices can take various forms such as smartphones, tablet computers, or laptop computers. More particularly, the mobile device includes a computing device that may be a small, portable electronic device, e.g., a mobile phone or smartphone, or, alternatively, a personal data assistant (PDA), a personal media player device, an application specific device such as a tablet or slate computing device, or a hybrid device that may include any of the above functions. Nonlimiting examples of smartphones include devices running on Android or iPhone, for example, iOS platforms. Nonlimiting examples of tablet computing devices are IPADs available from Apple Corp.

Mobile devices 340 may also be in the form of a personal computer including both laptop computer and non-laptop, for example, and desktop computer configurations. Such devices include electronic data storage provisions, control provisions, communication provisions, and user interface provisions. The data storage provisions of mobile devices enable information relating to air travel customer or user information, including user-access, data-transfer, cancellation-queue review and/or analysis data permissions relating to user registration. The data storage provisions, in addition to disclosure set forth above, include a form of known data storage formats such as flash memory components.

The data storage provisions may also include or be in the form of memory cards, disk or drive components, data cartridges or components such as ROM or RAM memory, and peripheral data storage components. The control provisions of such mobile devices typically include electronic circuitry that is generally in the form of one or more processors.

The mobile devices also include communication provisions between the mobile device and one or more servers and between the mobile device and the registration and control component. Communication between the mobile device and a server can be established (or provided) by using one or more communication formats including radio frequency (“RF”), infrared (“IR”), and BLUETOOTH, as known in the art. In embodiments, communication is by a wireless local area network (“WLAN”), i.e., Wi-Fi. Mobile devices may be communicatively coupled to cloud-based service and data centers including a third-party entity via, e.g., at least a wireless local area network technology (WLAN), i.e., Wi-Fi. However, embodiments of local access to cloud-based storage are not limited to wireless communications, and therefore hard-wired communications may also apply to the embodiments described herein. The mobile devices also include communication provisions between mobile devices and registration components and control components.

Such internet communications typically make use of cloud-based infrastructure. Advantageously, the present subject matter includes the use of other communications between mobile devices and the registration and controller components. As previously noted, mobile devices include electronic data storage provisions and control provisions. In many embodiments of the present subject matter, the mobile device is configured to run or execute an algorithm or “app” as known in the art which facilitates communication with registration component and/or the controller component of the present subject matter. Software involving such algorithms (or “apps”) including their transfer and/or download features, including the running and maintenance thereof are described, e.g., in U.S. Pat. No. 8,549,656 to Blaisdell et al.; U.S. Pat. No. 8,875,298 to Li et al.; U.S. Pat. No. 9,043,480 to Barton et al.; U.S. Pat. No. 9,100,390 to Asnis et al.; U.S. Pat. No. 9,135,418 to Wade et al.; and U.S. Pat. No. 9,246,893 to Boyer et al., each of which is hereby incorporated by reference in its entirety. Algorithms or apps may facilitate administration of permissions from the registration component including the controller component, the transmission of data or information between the registration and control components, and mobile devices.

For the system 300 illustrated by FIG. 3, the storage device 344 includes means for notifying said one or more project-funds distributors 328 when candidate gift amounts in the predetermined storage register match or exceed the target crowdfunding amount. In particular, the present subject matter contemplates situations where candidate gift amounts in the predetermined storage register exceed the target crowdfunding amount in ranges of from about 5% to about 50%, or about 10% to about 40% or about 15% to about 35%. Such ranges, often referred to as “margins” by project enablers 324, provide such enablers 324 with profits for providing services or funding crowdfunding projects. Further in accordance with the present subject matter, it is contemplated that a vast assortment of financial investors would be happy to invest their funds or services in crowdfunding projects estimated to yield a profit margin of from about 5% to about 35%

For the system 300 shown in FIG. 3, an amount in the storage register matching the target amount is electronically transferred to a secure funds account of the candidate 310 by said one or more project-funds distributors 328 when notified by the notifying means of the storage device 344 and a remainder amount in the storage device 344 is electronically transferred to a secure account of said one or more project enablers 324.

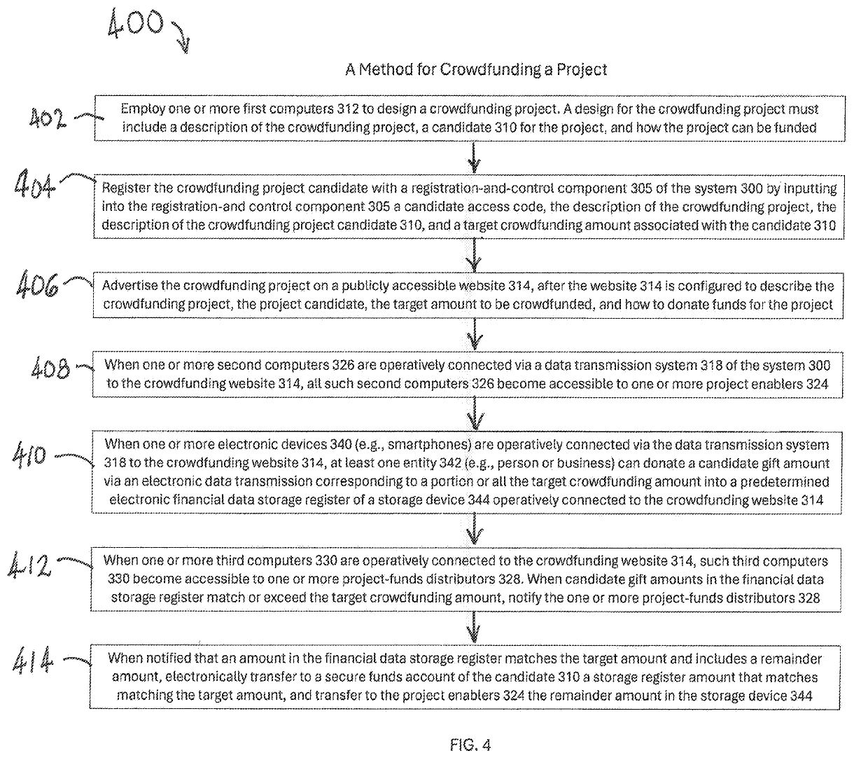

FIG. 4, a schematic illustration presenting an embodiment of an example of a method 400 for crowdfunding a project, in accordance with principles of the present subject matter, shall now be described in detail. The illustrated method 400 utilizes or employs, step 402, one or more first computers 312 to design a crowdfunding project. A design for a crowdfunding project may include, but not be limited to, a description of the crowdfunding project, a description of a candidate 310 for the crowdfunding project, and a description as to how the crowdfunding project can be funded. Another step associated with method 400, step 404, includes registering the crowdfunding project candidate with a registration-and-control component 305. Registration with control component 305 can be executed by “keying into” registration-and-control component 305 an access code for each candidate, a description of a crowdfunding project, a description of each project candidate, and a target crowdfunding amount associated with each project candidate 310.

Another step associated with method 400, step 406, includes advertising the crowdfunding project on a publicly accessible website 314. Typically, each website 314 will have been designed, adapted, and configured to describe a crowdfunding project in sufficient detail, to introduce and describe what crowdfunding candidates seek to achieve, to state each target amount to be crowdfunded, and describe and explain how members of the public and other potential donors can donate via electronic transfer for each project.

In operation, one or more second computers 326 are operatively connected via the data transmission system 318 to the crowdfunding website 314 and the second computers 326 are accessible by one or more project enablers. In addition, one or more third computers 330 are operatively connected to the crowdfunding website 314, and the third computers 330 are accessible, step 408, by one or more project-funds distributors 328. One or more electronic devices 340 are operatively connected, step 410, via the data transmission system 318 to the crowdfunding website 314. Step 410 enables at least one entity 342 to donate a candidate gift amount via electronic financial data transmission corresponding to a portion, or all, of the target crowdfunding amount into a predetermined electronic financial data storage register of a storage device 344 operatively connected to crowdfunding website 314. The storage device 344 includes a server 320 operatively connected to the crowdfunding website 314. Another step associated with method 400 includes configuring server 320 to receive and securely store at least one candidate gift amount donated by at least one entity 342 via said electronic financial data transmission.

In addition, the storage device 344 includes a database 322 operatively connected to the crowdfunding website 314. Another step associated with method 400 includes configuring the database 322 to securely store an access code for each candidate, a description of each project to be crowdfunded, and a target crowdfunding amount associated with each project candidate 310 registered with the registration-and-control component 305. Another step associated with method 400, step 412, includes notifying one of the project-funds distributors 328 when candidate gift amounts in predetermined storage register match or exceed the target crowdfunding amount. In particular, method 400 includes notifying said one or more project-funds distributors 328 when candidate gift amounts in the storage register exceed the target crowdfunding amount by 5% to 35%. When notified that an amount in the storage register matches the target amount and includes a remainder amount, another step, step 414, for the method 400 shown includes electronically transferring to a secure funds account of candidate 310 an amount in the storage register matching the target amount, and electronically transferring to a secure account of one or more project enablers 324 the remainder amount in storage device 344.

What has been described in detail throughout this patent specification are improved methods and systems for crowdfunding a project. Accordingly, while the present subject matter has been described with reference to exemplary embodiments, the present subject matter is not limited to these embodiments. On the contrary, many alternatives, changes, and modifications shall become apparent to a person of ordinary skill in the art (“POSITA”) after this patent specification and its figures are reviewed. A POSITA will certainly appreciate that many assorted other projects are possible. Thus, all alternatives, changes, and/or modifications shall be understood as forming a part of the present subject matter insofar as they fall within the spirit and the scope of the appended claims.

I claim:

1. A system (300) for crowdfunding a project, comprising:
one or more first computers (312), wherein each one of the first computers (312) is accessible by at least one crowdfunding project candidate (310);
a registration-and-control component (305), wherein a data transmission system (318) operatively connected to the first computers (312) transmits data between the first computers (312) and the control component (305) after the project candidate (310) has become registered with the control component (305) by inputting into the control component (305) an access code, a description of a project to be crowdfunded, and a target crowdfunding amount associated with a crowdfunding project candidate (310); and
a crowdfunding website (314) describing the project to be crowdfunded including the target crowdfunding amount, wherein the crowdfunding website (314) is operatively connected to the control component (305);
wherein one or more second computers (326) are operatively connected via the transmission system (318) to the crowdfunding website (314) and the second computers (326) are accessible by one or more project enablers (324);
wherein one or more third computers (330) are operatively connected to the crowdfunding website (314), wherein one or more of the third computers 330 is accessible by one or more project-funds distributors (328); and
wherein one or more electronic devices (340) operatively connected via the data transmission system (318) to the crowdfunding website (314) enable at least one entity (342) to donate a candidate gift amount via an electronic financial data transmission corresponding to a portion or all the target crowdfunding amount into a predetermined electronic financial data storage register of a storage device (344) operatively connected to the crowdfunding website.

2. The system (300) of claim 1, wherein the storage device (344) comprises a server (320) operatively connected to the crowdfunding website (314), wherein the server (320) is adapted and configured to receive and securely store at least one candidate gift amount donated by said at least one entity (342) via said electronic financial data transmission.

3. The system (300) of claim 1, wherein the storage device (344) includes a database (322) operatively connected to the crowdfunding website (314), wherein the database (322) is adapted and configured to securely store an access code, a description of a project to be crowdfunded, and a target crowdfunding amount associated with a crowdfunding project candidate (310) registered with the control component (305).

4. The system (300) of claim 1, wherein said at least one entity comprises at least one person.

5. The system (300) of claim 1, wherein said at least one entity comprises at least one business entity.

6. The system (300) of claim 1, wherein said at least one project enabler (324) comprises at least one crowdfunding project funder.

7. The system (300) of claim 1, wherein said at least one project enabler (324) comprises at least one crowdfunding project services provider.

8. The system (300) of claim 1, wherein the storage device (344) includes means for notifying said one or more project-funds distributors (328) when candidate gift amounts in the predetermined storage register match or exceed the target crowdfunding amount.

9. The system (300) of claim 1, wherein the storage device (344) includes means for notifying said one or more project-funds distributors (328) when gift amounts in the predetermined storage register exceed the target crowdfunding amount by 5% to 35%.

10. The system (300) of claim 9, wherein an amount in the storage register matching the target amount is electronically transferred to a secure funds account of the candidate (310) by said one or more project-funds distributors (328) when notified by the notifying means of the storage device (344) and a remainder amount in the storage device (344) is electronically transferred to a secure account of the one or more project enablers.

11. A method (400) for crowdfunding a project, comprising:
utilizing one or more first computers (312) to design a crowdfunding project, wherein a design for the crowdfunding project includes a description of the crowdfunding project, a description of a candidate (310) for the crowdfunding project, and a description as to how the crowdfunding project can be funded;
registering the crowdfunding project candidate with a registration-and-control component (305) by inputting into the control component (305) a candidate access code, the description of the crowdfunding project, the description of the crowdfunding project candidate, and a target crowdfunding amount associated with the crowdfunding project candidate (310); and
advertising the crowdfunding project on a publicly accessible website (314), wherein the website (314) has been adapted and configured to describe the crowdfunding project, the crowdfunding candidate, the target amount to be crowdfunded, and how to donate funds via electronic transfer for the project;
wherein one or more second computers (326) are operatively connected via a data transmission system (318) to the crowdfunding website, wherein the second computers are accessible by one or more project enablers (324);
wherein one or more third computers (330) are operatively connected to the crowdfunding website (314), and wherein the third computers (330) are accessible by one or more project-funds distributors (328); and
wherein one or more electronic devices (340) operatively connected via the data transmission system (318) to the crowdfunding website (314), enable at least one entity (342) to donate a candidate gift amount via an electronic financial data transmission corresponding to a portion or all of the target crowdfunding amount into a predetermined electronic financial data storage register of a storage device (344) operatively connected to the crowdfunding website.

12. The method (400) of claim 11, wherein the storage device (344) comprises a server (320) operatively connected to the crowdfunding website (314), including the step of configuring the server (320) to receive and securely store at least one candidate gift amount donated by said at least one entity (342) via said electronic financial data transmission.

13. The method (400) of claim 11, wherein the storage device (344) includes a database (322) operatively connected to the crowdfunding website (314), including the step of configuring the database (322) to securely store an access code, a description of a project to be crowdfunded, and a target crowdfunding amount associated with a crowdfunding project candidate (310) registered with the control component (305).

14. The method (400) of claim 11, wherein said at least one entity comprises at least one person.

15. The method (400) of claim 11, wherein said at least one entity comprises at least one business entity.

16. The method (400) of claim 11, wherein said at least one project enabler (324) comprises at least one crowdfunding project funder.

17. The method (400) of claim 11, wherein said at least one project enabler (324) comprises at least one crowdfunding project services provider.

18. The method (400) of claim 11, including the step of notifying said one or more of said project-funds distributors (328) when candidate gift amounts in the predetermined storage register match or exceed the target crowdfunding amount.

19. The method (400) of claim 11, including the step of notifying said one or more of said project-funds distributors (328) when candidate gift amounts in the predetermined storage register exceed the target crowdfunding amount by about 5% to about 35%.

20. The method (400) of claim 19, when notified that an amount in the storage register matches the target amount and includes a remainder amount, including the step of transferring to a secure funds account of the candidate (310) an amount in the storage register matching the target amount, and the step of transferring to a secure account of said one or more project enablers (324) the remainder amount in the storage device (344).
